(19) United States
(12) Patent Application Publication
(10) Pub. No.: US 2026/0208485 A1
(43) Pub. Date: Jul. 23, 2026

(54) PRINTING ELEMENT SUBSTRATE AND LIQUID EJECTION HEAD

(71) Applicant: CANON KABUSHIKI KAISHA, Tokyo (JP)

(72) Inventors: YOSHIHIRO HAMADA, Kanagawa (JP); KEIJI TOMIZAWA, Kanagawa (JP); TAKATSUGU MORIYA, Tokyo (JP); KOICHI ISHIDA, Tokyo (JP); SAORI NARUKAWA, Kanagawa (JP); TAKUMA KODOI, Kanagawa (JP)

(21) Appl. No.: 19/414,934

(22) Filed: Dec. 10, 2025

(30) Foreign Application Priority Data
Jan. 23, 2025 (JP) 2025-009782

(51) Int. Cl. B41J 2/14; B41J 2/175

(52) U.S. Cl. CPC B41J 2/14201; B41J 2/1433; B41J 2/17563; B41J 2002/14306

(57) ABSTRACT

In a printing element substrate, a substrate, a flow channel formation unit, and an ejection port formation unit are connected to each other in this order. In the substrate, a first supply port and a second supply port are formed adjacent to each other in a first direction. In the flow channel formation unit, a first support unit and a second support unit are formed between the first supply port and the second supply port. In the first direction, a distance from the first support unit to a midpoint between the first support unit and the second support unit is longer than a distance from the first support unit to the first supply port, and a distance from the second support unit to the midpoint between the first support unit and the second support unit is longer than a distance from the second support unit to the second supply port.

### BACKGROUND

### Field of the Technology

The present invention relates to a printing element substrate and a liquid ejection head.

### Description of the Related Art

In a field of a liquid ejection apparatus that ejects a liquid, in order to efficiently use generated energy as ejection energy, it is demanded to make the thickness of an ejection port formation unit thin, in which an ejection port to eject the liquid is formed. However, in a case where the ejection port formation unit is made thin, there is a possibility that the strength of the ejection port formation unit is decreased, and the ejection port formation unit is broken.

Japanese Patent Laid-Open No. 2017-209791 discloses a printing element substrate in which multiple support units are formed to support an ejection port formation member (an ejection port formation unit) between two supply ports formed along a predetermined direction. According to the printing element substrate of Japanese Patent Laid-Open No. 2017-209791 (hereinafter, referred to as a conventional technique as needed), the shear stress is reduced, and the stress applied to the support units is distributed. Therefore, according to the conventional technique, suppression of a decrease in the strength of the ejection port formation member against the external force and also suppression of the stress concentration in the support units due to the swelling of the ejection port formation member are implemented. As a result, there is an expectation that the ejection port formation member is made thinner.

### SUMMARY

Japanese Patent Laid-Open No. 2017-209791 discloses arrangement of the support unit. On the other hand, in the conventional technique, a contribution of the arrangement of the support unit to the suppression of the shear stress has not been considered.

The present disclosure is to provide a printing element substrate that can suppress the generation of the shear stress more than the conventional technique and can eventually suppress breakage of an ejection port formation unit.

A printing element substrate includes: a substrate in which multiple energy generation elements configured to generate energy to eject a liquid are formed; a flow channel formation unit in which a flow channel is formed; and an ejection port formation unit in which multiple ejection ports to eject the liquid are formed, in which the substrate, the flow channel formation unit, and the ejection port formation unit are connected to each other in this order, in the substrate, multiple supply ports including a first supply port and a second supply port adjacent to each other in a first direction and configured to supply the ejection ports with the liquid are formed, in the flow channel formation unit, a first support unit and a second support unit configured to support the ejection port formation unit are formed between the first supply port and the second supply port, and in the first direction, a distance from the first support unit to a midpoint between the first support unit and the second support unit is longer than a distance from the first support unit to the first supply port, and a distance from the second support unit to the midpoint between the first support unit and the second support unit is longer than a distance from the second support unit to the second supply port.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic perspective view illustrating an example of a liquid ejection apparatus that is applicable to an embodiment;

FIG. 2 is a schematic perspective view illustrating an example of a liquid ejection head that is applicable to an embodiment;

FIG. 3A is a schematic bottom view of a printing element substrate;

FIG. 3B is a cross-sectional view taken along a IIIb-IIIb line in FIG. 3A;

FIG. 4 is a diagram describing an effect of a support unit in an embodiment;

FIG. 5 is a diagram describing the effect of the support unit in a first comparative example;

FIG. 6 is a diagram describing the effect of the support unit in a second comparative example;

FIG. 7 is a table illustrating effects of an embodiment, the first comparative example, and the second comparative example;

FIG. 8 is a schematic view of the printing element substrate that is applicable to an embodiment;

FIG. 9 is a schematic view of the printing element substrate that is applicable to an embodiment;

FIG. 10 is a schematic view of the printing element substrate that is applicable to an embodiment; and

FIG. 11 is a schematic view of the printing element substrate that is applicable to an embodiment.

### DESCRIPTION OF THE EMBODIMENTS

### First Embodiment

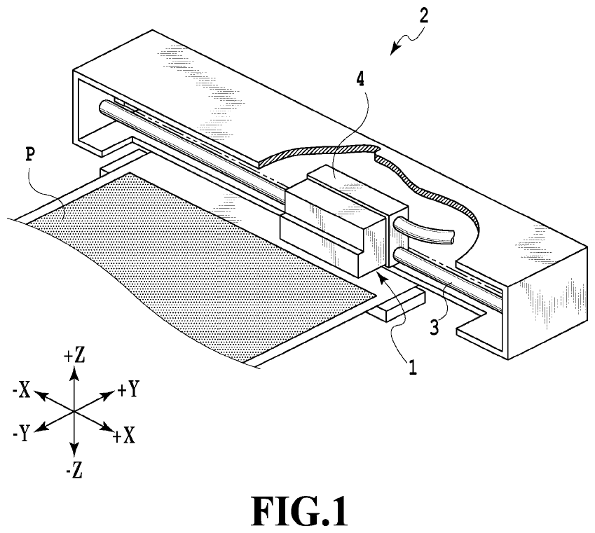

FIG. 1 is a schematic perspective view illustrating an example of a liquid ejection apparatus 2 that is applicable to the present embodiment.

In the drawings referred to herein, an X direction and a Y direction represent two directions orthogonal to each other on a horizontal plane. A Z direction represents a vertical direction. Additionally, a +Y direction represents a front side of the liquid ejection apparatus 2, a −Y direction represents a rear side, a −X direction represents a left side, a +X direction represents a right side, a +Z direction represents an upper side, and a −Z direction represents a lower side, respectively. Moreover, in the descriptions below, unless otherwise stated, the upper side, the lower side, and the right and left represent directions in a case of facing a front face of the liquid ejection apparatus 2 in an orientation of using the liquid ejection apparatus 2 in a normal state.

In the present disclosure, “printing” involves not only forming significant information (such as a character or a graphic that is visible to be visually sensed by a human, for example). “Printing” also means forming insignificant information. In addition, in the present disclosure, “printing” widely means forming an image, a design, a pattern, a structure, a combination thereof, or the like on a printing medium P or also processing the medium.

Additionally, as the printing medium P, it is possible to use a medium of various materials and forms such as paper, cloth, an optical disc label surface, a plastic sheet, an OHP sheet, and an envelope, for example.

As illustrated in FIG. 1, the liquid ejection apparatus 2 includes a liquid ejection head 1 that ejects a liquid (for example, an ink), a carriage 4 formed so as to be able to attach and detach the liquid ejection head 1 thereto and therefrom, and a guide shaft 3 that guides the carriage 4 in a scan direction (the ±X directions). The liquid ejection apparatus 2 includes a conveyance unit that conveys the printing medium P in a conveyance direction (the −Y direction) (for example, a not-illustrated conveyance roller) and an automatic feeding unit that feeds the printing medium P automatically to the inside of an apparatus main body (for example, a not-illustrated auto-feeder).

In the present embodiment, the carriage 4 is supported by the guide shaft 3 extending along the scan direction so as to reciprocally move along the scan direction. The liquid ejection apparatus 2 is formed so as to be able to relatively move the liquid ejection head 1 with respect to the printing medium P in a state in which the liquid ejection head 1 is mounted on the carriage 4. The liquid ejection apparatus 2 includes a driving force transfer mechanism (not illustrated) to drive the carriage 4. The carriage 4 is formed to be able to reciprocally move along the scan direction by the driving force transfer mechanism.

With the above-described configuration, while the carriage 4 reciprocally scans at a predetermined speed in an outward direction or a homeward direction, the liquid ejection head 1 ejects the liquid according to ejection data, and thus an image of one band is printed on the printing medium P. In addition, the printing scan (relative scan) of one band as described above and a conveyance operation of the printing medium P in the conveyance direction crossing (in the present embodiment, orthogonal to) the printing scan are repeated intermittently, and thus the image is printed on the printing medium P in stages. Thus, in the present embodiment, it is possible to use a so-called serial type ink jet printer as the liquid ejection apparatus 2.

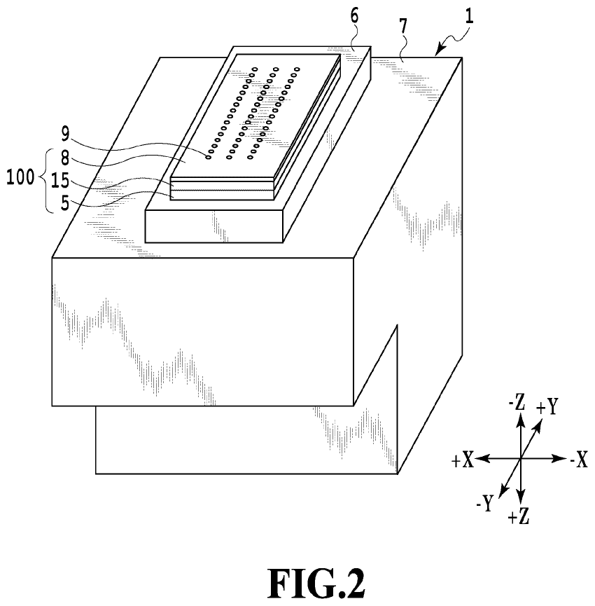

FIG. 2 is a schematic perspective view illustrating an example of the liquid ejection head 1 that is applicable to the present embodiment. In FIG. 2, the XYZ directions correspond to the directions in a case where the liquid ejection head 1 is mounted in the liquid ejection apparatus 2.

As illustrated in FIG. 2, the liquid ejection head 1 is formed by laminating a main body 7, a connection member 6, and a printing element substrate 100 in this order. A top surface of the connection member 6 (a surface facing in the +Z direction in FIG. 2) is fixed (for example, bonded) on a bottom surface of the main body 7 (a surface facing in the −Z direction in FIG. 2). A top surface of the printing element substrate 100 (a surface facing in the +Z direction in FIG. 2) is fixed (for example, bonded) on a bottom surface of the connection member 6 (a surface facing in the-Z direction in FIG. 2).

The printing element substrate 100 is formed by laminating a substrate 5, a flow channel formation member 15, and an ejection port formation member 8 in this order. A top surface of the substrate 5 (a surface facing in the +Z direction in FIG. 2) is fixed (for example, bonded) on the bottom surface of the connection member 6 (the surface facing in the −Z direction in FIG. 2). A top surface of the flow channel formation member 15 (a surface facing in the +Z direction in FIG. 2) is fixed (for example, bonded) on a bottom surface of the substrate 5 (a surface facing in the −Z direction in FIG. 2). A top surface of the ejection port formation member 8 (a surface facing in the +Z direction in FIG. 2) is fixed (for example, bonded) on a bottom surface of the flow channel formation member 15 (a surface facing in the −Z direction in FIG. 2).

Multiple ejection ports 9 ejecting the liquid are formed on an ejection port surface of the ejection port formation member 8 (a surface facing in the-Z direction in FIG. 2) along an array direction (in the present embodiment, the Y direction). An array of the ejection port array is formed by forming the multiple ejection ports 9 along the array direction. For example, on the ejection port surface, an ejection port array ejecting a black ink and multiple ejection port arrays ejecting color inks are arranged in the X direction.

Additionally, with the lamination of the main body 7, the connection member 6, and the printing element substrate 100 in this order, a flow channel supplying the liquid from the main body 7 to the ejection ports 9 is formed. According to this configuration, it is possible to supply the liquid stored in a tank (not illustrated) to the main body 7, the connection member 6, the substrate 5, the flow channel formation member 15, and the ejection port formation member 8 sequentially in this order and eject the liquid from the ejection ports 9.

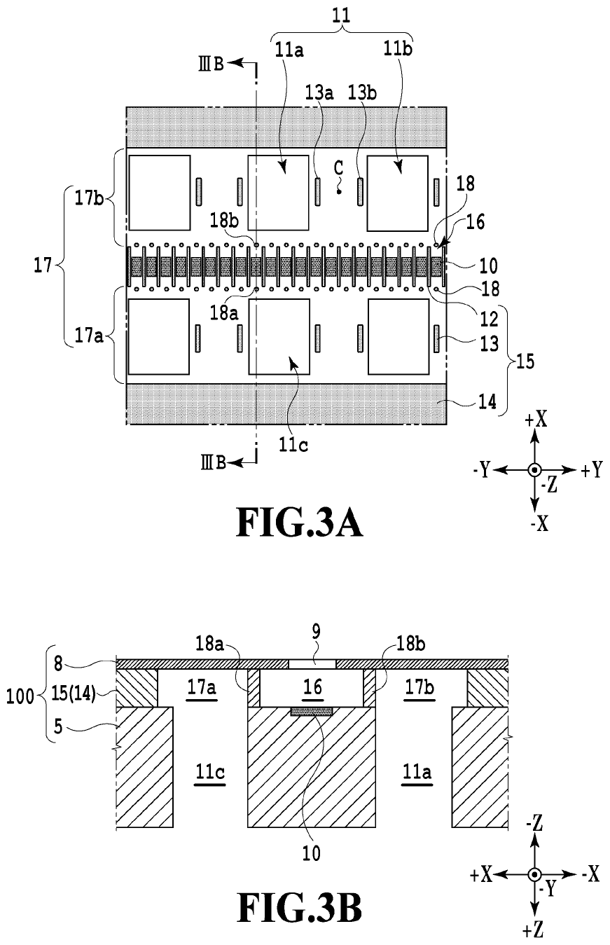

FIG. 3A is a schematic bottom view of the printing element substrate 100. Note that, in FIG. 3A, the ejection port formation member 8 (see FIG. 2 and the like) is not illustrated for the sake of explanatory convenience. Additionally, FIG. 3B is a cross-sectional view taken along a IIIb-IIIb line in FIG. 3A. In FIG. 3B, the ejection port formation member 8 is illustrated.

As illustrated in FIG. 3A, the substrate 5 includes an energy generation element 10 that generates energy to eject the liquid. In the present embodiment, each array of the element array is formed by providing multiple energy generation elements 10 along a first direction (the Y direction).

Multiple supply ports 11 to supply the liquid from the substrate 5 to the flow channel formation member 15 are formed in the substrate 5. Each of the multiple supply ports 11 is formed to penetrate a main body of the substrate 5 in a thickness direction (the Z direction). The multiple supply ports 11 include a first supply port 11a, a second supply port 11b, and a third supply port 11c. The first supply port 11a and the second supply port 11b are formed adjacent to each other in the first direction. The first supply port 11a and the third supply port 11c are formed adjacent to each other in a second direction (the X direction) crossing the first direction on a plane.

As illustrated in FIG. 3B, a common liquid chamber 17 supplied with the liquid from the supply port 11 of the substrate 5 and multiple liquid chambers 16 connected to the common liquid chamber 17 and corresponding to the individual energy generation element 10 are formed in the flow channel formation member 15.

The common liquid chamber 17 includes a first common liquid chamber 17a and a second common liquid chamber 17b adjacent to each other in the second direction. The first common liquid chamber 17a is supplied with the liquid from the third supply port 11c. The second common liquid chamber 17b is supplied with the liquid from the first supply port 11a and the second supply port 11b.

The flow channel formation member 15 includes a partition 12, a support unit 13, and a flow channel wall 14. The partition 12 is provided between the two energy generation elements 10 adjacent to each other in the first direction. The support unit 13 is provided between the first supply port 11a and the second supply port 11b. In the present embodiment, the support unit 13 includes a first support unit 13a, and a second support unit 13b adjacent to each other in the first direction with no supply port 11 being arranged therebetween. The support unit 13 supports the ejection port formation member 8.

The ejection port formation member 8 is a comparatively thin plate-shaped member. Accordingly, in a case of ejecting the liquid, there is a concern that the ejection port formation member 8 receives the generated energy and is deformed and broken. With the support unit 13 being provided, such deformation is suppressed; however, particularly, a portion of the ejection port formation member 8 that is facing the supply port 11 is likely to be deformed more significantly than another portion in a case of ejecting the liquid, and there is a high possibility of breakage of the facing portion. For this reason, in the present embodiment, the support unit 13 is provided to a position as close as possible to the supply port 11 so as to decrease the deformation amount of the ejection port formation member 8. Hereinafter, specific description is provided.

In the present embodiment, a length of the supply port 11 in the first direction is 85.0 μm, and a length in the second direction is 101.5 μm. On the other hand, a length of the support unit 13 in the first direction is 7.0 μm, and a length in the second direction is 36.5 μm. According to the studies by the inventors, preferably, the length of the support unit 13 in the second direction is equal to or smaller than 60% of the length of the supply port 11 in the second direction. More preferably, the length of the support unit 13 in the second direction is equal to or smaller than 40% of the length of the supply port 11 in the first direction. The above-described numerical values satisfy the conditions.

Additionally, in the first direction, a distance from a right end portion of the first supply port 11 a to the center of the first support unit 13a is 10.0 μm or greater and 12.0 μm or smaller. A distance from the center of the first support unit 13a to the center of the first supply port 11 a is 31.0 μm or greater and 33.0 μm or smaller.

Moreover, in the first direction, a distance from a left end portion of the second supply port 11 b to the center of the second support unit 13 b is 10.0 μm or greater and 12.0 μm or smaller. A distance from the center of the second support unit 13b to the center of the second supply port 11 b is 31.0 μm or greater and 33.0 μm or smaller.

Furthermore, in the present embodiment, along the first direction, about 1200 ejection ports 9 per inch are formed in association with the individual energy generation element 10. That is, the density of the energy generation elements 10 and the liquid chambers 16 arrayed in the first direction is 1200 dpi. Additionally, about 150 supply ports 11 per inch are formed along the first direction. That is, the density of the supply ports 11 formed is 150 dpi. That is, in the present embodiment, a mode in which each supply port 11 supplies about eight liquid chambers 16 with the liquid is applied.

For example, it is possible to form about 150 supply ports 11 per inch by setting an interval between the centers of two supply ports 11 adjacent to each other in the first direction (an array pitch between the supply ports 11 in the first direction) to about 169.2 μm. Note that, the intervals between the adjacent two supply ports 11 are unnecessarily equal. Specifically, as long as the interval between the centers of the adjacent two supply ports 11 is 169.0 μm or greater and 169.5 μm or smaller, any interval may be applied. That is, as long as an average value of the interval between the centers of the adjacent two supply ports 11 is about 169.2 μm, it is possible to form about 150 supply ports 11 per inch.

According to the above configuration, the first support unit 13a is arranged such that the center thereof is at a position closer to the right end portion of the first supply port 11a than a midpoint C between the first supply port 11a and the second supply port 11b in the first direction. Additionally, the second support unit 13b is arranged such that the center thereof is at a position closer to the left end portion of the second supply port 11b than the midpoint C between the first supply port 11a and the second supply port 11b in the first direction. According to this configuration, comparing with a case where the support unit 13 is provided to a position away from the supply port 11 like the conventional technique, a range of movement of the ejection port formation member 8 in the Z direction is reduced, and the deformation amount of the ejection port formation member 8 along with an ejection operation is decreased. As a result, it is possible to suppress the shear stress and suppress the breakage of the ejection port formation member.

Additionally, in the flow channel formation member 15, the common liquid chamber 17, a filter 18, the partition 12, and the liquid chamber 16 are provided between two flow channel walls 14 adjacent to each other along the second direction. In the present embodiment, the partition 12 is formed linearly along the second direction. Between the two partitions 12 adjacent to each other in the first direction, the energy generation element 10 is provided, and the liquid chamber 16 is formed.

The filter 18 capturing a foreign substance in the liquid is provided near an inlet and outlet port of the liquid chamber 16. The filter 18 includes a first filter 18a and a second filter 18b provided to two sides of the liquid chamber 16 in the second direction, respectively. In the first direction, there is a small clearance between the filter 18 and the partition 12. This makes it possible to suppress the foreign substance from entering the liquid chamber 16 without interrupting a flow of the liquid supplied from the common liquid chamber 17 to the liquid chamber 16.

In the liquid chamber 16, liquid discharge and liquid supply by way of the inlet and outlet port of the liquid chamber 16 occur. First, the liquid discharge is described. The liquid discharge occurs during a liquid ejection operation. In two flows, which are a flow toward an ejection port side (that is, a front side in an ejection direction) and a flow toward an inlet and outlet port side of the liquid chamber 16 (that is, a rear side in the ejection direction), the flow toward the rear side in the ejection direction is referred to as the liquid discharge.

Next, the liquid supply is described. The liquid supply occurs in a case where the liquid ejection operation is completed. Once the liquid is ejected, the liquid chamber 16 is refilled with the liquid of an amount ejected from the liquid chamber 16 through the ejection port 9. This phenomenon is referred to as the liquid supply.

A width of the inlet and outlet port of the liquid chamber 16 (the size in the Y direction) is determined by balancing the liquid discharge and the liquid supply. For example, with the width of the inlet and outlet port of the liquid chamber 16 being made narrower than a central portion of the liquid chamber 16, it is possible to eject the liquid with small energy. This is because a resistance on the front side in the ejection direction becomes relatively small by making the inlet and outlet port of the liquid chamber 16 narrower than another portion (for example, a portion corresponding to the energy generation element 10), and increasing a resistance in the liquid discharge direction.

On the other hand, with the width of the inlet and outlet port of the liquid chamber 16 being made wide, it is possible to make an ejection cycle of the liquid fast. This is because a flow resistance that is generated during the liquid supply is reduced by making the width of the inlet and outlet port of the liquid chamber 16 wide, and thus the refilling with the liquid can be performed quickly. In the present embodiment, priority is given to the fast liquid ejection cycle over the liquid ejection with small energy. Therefore, a straight shape that allows for the minimum resistance in the inlet and outlet port is adopted to the liquid chamber 16 of the present embodiment.

As illustrated in FIG. 3B, the energy generation element 10 is provided to a position corresponding to the ejection port 9 in the liquid chamber 16. In the present embodiment, a heater that performs heating by being supplied with power is used as the energy generation element 10. That is, in the present embodiment, a so-called thermal type printing method is adopted. Once the heater is supplied with power in a state in which the liquid chamber 16 is supplied with the liquid, a bubble is generated in the liquid in the liquid chamber 16. With the bubble generation energy, a liquid droplet is ejected from the ejection port 9 in the −Z direction.

Additionally, each of the third supply port 11c and the first supply port 11a is formed to penetrate the main body of the substrate 5 in the thickness direction (the Z direction). The third supply port 11c is connected to the first common liquid chamber 17a. The first common liquid chamber 17a is connected to the liquid chamber 16 with the first filter 18a being arranged therebetween. On the other hand, the first supply port 11a is connected to the second common liquid chamber 17b. The second common liquid chamber 17b is connected to the liquid chamber 16 with the second filter 18b being arranged therebetween.

Thus, in the present embodiment, the liquid chamber 16 is supplied with the liquid from two sides in the second direction (the X direction). Thus, comparing with a case where the liquid chamber 16 is supplied with the liquid from one side in the second direction, it is possible to improve the symmetry of the liquid flows in a case of ejecting the liquid. Accordingly, according to the configuration of the present embodiment, it is possible to improve the performance of straight ejection of the ejected liquid droplet. That is, according to the configuration of the present embodiment, comparing with a case where the liquid chamber 16 is supplied with the liquid from one side in the second direction, landing of the liquid droplet to a desired position is easier, and it is possible to improve the image quality.

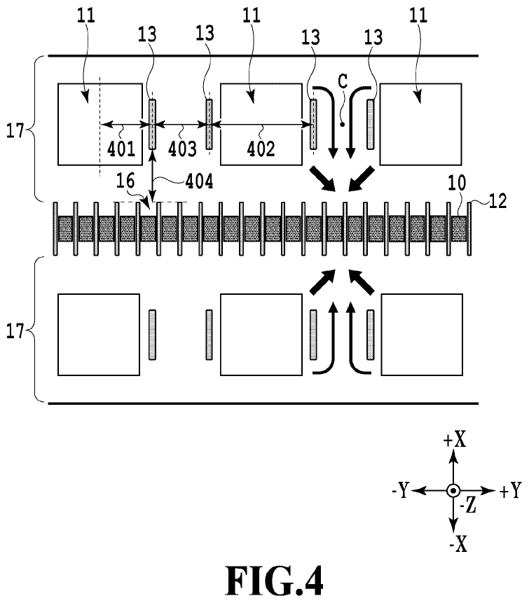

Hereinafter, an effect of the present embodiment is described with reference to FIGS. 4, 5, 6, and 7.

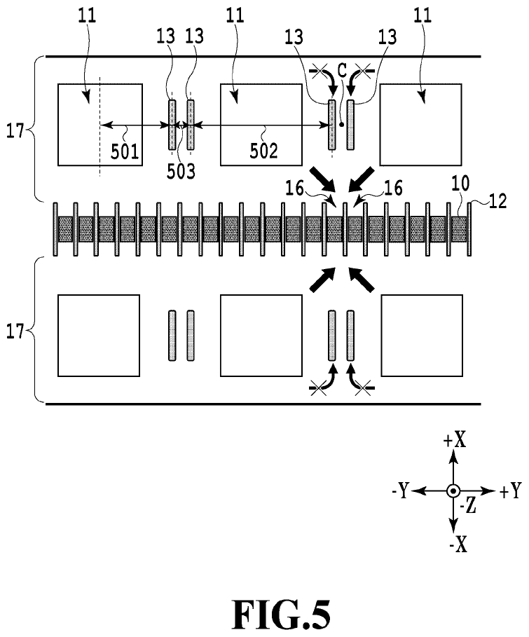

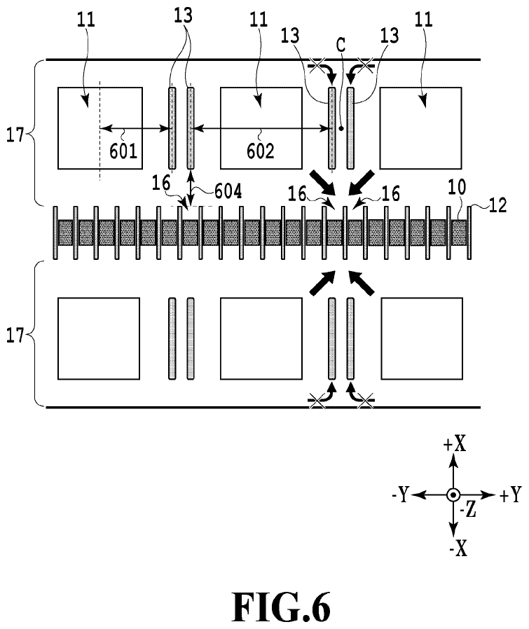

FIG. 4 is a diagram describing an effect of the support unit 13 in the present embodiment. Additionally, FIGS. 5 and 6 are diagrams illustrating examples to be compared with FIG. 4. In FIG. 4, the two support units arranged between the two supply ports are arranged at positions closer to the corresponding supply ports than the center points of the two supply ports. In contrast, in FIG. 5 illustrating a first comparative example and FIG. 6 illustrating a second comparative example, the two support units arranged between the two supply ports are arranged at positions closer to the center points of the two supply ports than the corresponding supply ports. Additionally, the length of the support unit 13 in the second direction in the second comparative example is longer than that in the present embodiment and does not satisfy the condition, which is equal to or smaller than 60% of the length of the supply port. Note that, an arrow in the diagrams represents the flow of the liquid.

As illustrated in FIG. 4, a distance 401 in the first direction (the Y direction) from the center of the supply port 11 to the center of the support unit 13 at the nearest position in the present embodiment is shorter than a distance 501 in the first direction from the center of the supply port 11 to the center of the support unit 13 in the first comparative example in FIG. 5. In addition, the distance 401 in the present embodiment is shorter than a distance 601 in the first direction from the center of the supply port 11 to the center of the support unit 13 in the second comparative example illustrated in FIG. 6. Note that, as described above, the length of the distance 401 satisfies the condition of 10.0 μm or greater and 12.0 μm or smaller.

As described above, there is a possibility that the portion of the ejection port formation member 8 (see FIG. 2 and the like) that is facing the supply port 11 is deformed more significantly than the other portion in a case of ejecting the liquid. However, with the support unit 13 being provided near the supply port 11 like the present embodiment, comparing with the first and second comparative examples, it is possible to decrease the deformation amount of the portion of the ejection port formation member 8 that is facing the supply port 11. Thus, comparing with the first and second comparative examples, it is possible to reduce the possibility of the breakage of the ejection port formation member 8.

In the present embodiment, an interval 402 between the centers of the two support units 13 adjacent to each other in the first direction with the one supply port 11 being arranged therebetween is shorter than intervals 502 and 602 between the centers of the two support units 13 adjacent to each other with the one supply port 11 being arranged therebetween in the first and second comparative examples illustrated in FIGS. 5 and 6.

Specifically, a length of the interval 402 between the centers of the two support units 13 adjacent to each other in the first direction with the one supply port 11 being arranged therebetween is 105.0 μm or greater and 109.0 μm or smaller. On the other hand, an interval 403 between the centers of the two support units 13 adjacent to each other in the first direction with no supply port 11 being arranged therebetween is 60.0 μm or greater and 64.0 μm or smaller.

Thus, in the present embodiment, comparing with the first comparative example and the second comparative example, all the support units 13 are provided at comparatively equal intervals along the first direction. Thus, in the present embodiment, comparing with the first comparative example and the second comparative example, it is possible to decrease the deformation amount of the ejection port formation member 8 and make the ejection port formation member 8 resistant to the stress.

Additionally, the length of the support unit 13 in the second direction (the X direction) in the present embodiment is shorter than the length of the support unit 13 in the second direction in the second comparative example. Therefore, a distance 404 in the second direction from the support unit 13 to the liquid chamber 16 in the present embodiment is longer than a distance 604 (see FIG. 6) in the second direction (the X direction) from the support unit 13 to the liquid chamber 16 in the second comparative example. That is, the flow of the liquid is less likely to be inhibited by the support unit 13.

Thus, in the present embodiment, the support unit 13 is provided near the supply port 11. As a result, the interval 403 between the two support units 13 adjacent to each other in the first direction with no supply port 11 being arranged therebetween is wide. In addition, in the present embodiment, the length of the support unit 13 in the second direction is formed shorter than that in the conventional technique. As a result, the distance 404 from the support unit 13 to the liquid chamber 16 is increased.

According to this configuration, comparing with the first comparative example and the second comparative example, in the common liquid chamber 17 of the present embodiment, it is possible to make a space to flow the liquid wide, and also the flow of the liquid is less likely to be inhibited by the support unit 13. As a result, in the present embodiment, comparing with the first comparative example and the second comparative example, the decrease in the supply amount of the liquid to the liquid chamber 16 is suppressed, and it is possible to obtain the stable liquid ejection performance.

FIG. 5 is a diagram describing the effect of the support unit 13 in the first comparative example. Note that, the arrow in FIG. 5 represents the flow of the liquid, and “×” indicates that the flow of the liquid is inhibited.

As illustrated in FIG. 5, the length of the support unit 13 in the second direction (the X direction) in the first comparative example is almost the same as that in the present embodiment (see FIG. 4 and the like). Accordingly, the flowability of the liquid along the first direction (the Y direction) in the first comparative example is almost the same as the flowability of the liquid along the first direction (the Y direction) in the present embodiment.

However, in the first comparative example, the interval 502 between the two support units 13 adjacent to each other in the first direction with the one supply port 11 being arranged therebetween is wider than the interval 402 (see FIG. 4 and the like) between the two support units 13 adjacent to each other with the one supply port 11 being arranged therebetween in the present embodiment. Accordingly, in the configuration of the first comparative example, there is a major concern of more significant deformation of the portion of the ejection port formation member that is facing the supply port 11 than that in the present embodiment in a case of ejecting the liquid. As a result, the possibility of the breakage of the portion of the ejection port formation member that is facing the supply port 11 is increased more than that in the present embodiment.

Additionally, in the first comparative example, an interval 503 between the two support units 13 adjacent to each other with no supply port 11 being arranged therebetween is narrower than the interval 403 in the present embodiment (see FIG. 4 and the like). Thus, the resistance of the liquid passing between the support unit 13 is greater than that in the present embodiment, and the liquid supply is inhibited. Accordingly, in the configuration of the present comparative example, comparing with the present embodiment, the supply amount of the liquid to the liquid chamber 16 is decreased, and it is difficult to obtain the stable liquid ejection performance.

FIG. 6 is a diagram describing the effect of the support unit 13 in the second comparative example. Note that, the arrow in FIG. 6 represents the flow of the liquid, and “×” indicates that the flow of the liquid is inhibited.

As illustrated in FIG. 6, the interval 602 between the two support units 13 adjacent to each other along the first direction with the one supply port 11 being arranged therebetween in the second comparative example is wider than the interval 402 (see FIG. 4 and the like) in the present embodiment. However, on the other hand, the length of the support unit 13 in the second direction (the X direction) is longer than that in the present embodiment. Therefore, even though the interval 602 between the two support units 13 adjacent to each other along the first direction with the one supply port 11 being arranged therebetween is equivalent to that in the first comparative example, the effect of suppressing the deformation of the ejection port formation member is higher than that of the first comparative example.

However, in a case of the second comparative example, since the length of the support unit 13 in the second direction is longer than that in the present embodiment, the distance 604 in the second direction from the support unit 13 to the liquid chamber 16 is shorter than the distance 404 in the second direction from the support unit 13 to the liquid chamber 16 in the present embodiment. Thus, in the corresponding common liquid chambers 17, the resistance of the liquid flowing along the first direction is greater than that in the present embodiment, and the liquid supply is inhibited. Accordingly, in the configuration of the second comparative example, comparing with the present embodiment, the supply amount of the liquid to the liquid chamber 16 is decreased, and it is difficult to obtain the stable liquid ejection performance.

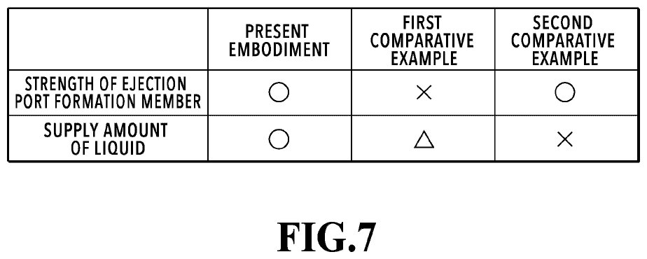

FIG. 7 is a table illustrating the effects of the present embodiment, the first comparative example, and the second comparative example.

As illustrated in FIG. 7, according to the configuration of the present embodiment, it is possible to achieve both the strength of the ejection port formation member 8 (see FIG. 2 and the like) and supply amount of the liquid to the liquid chamber 16 (see FIG. 4 and the like).

In the configuration of the first comparative example, the strength of the ejection port formation member is weaker than that in the present embodiment and second comparative example. The supply amount of the liquid from the supply port 11 (see FIG. 5) to the liquid chamber 16 (see FIG. 5) is greater than that in the second comparative example but is smaller than that in the present embodiment.

In the configuration of the second comparative example, it is possible to obtain the strength of the ejection port formation member close to that in the present embodiment. However, the supply amount of the liquid from the supply port 11 (see FIG. 6) to the liquid chamber 16 (see FIG. 6) is smaller than that in the first comparative example.

As described above, in the present embodiment, the two support units 13 (see FIG. 4 and the like) adjacent to each other in the first direction with the supply port 11 (see FIG. 4 and the like) being arranged therebetween is provided to the position close to the supply port 11. Thus, comparing with a case where the support unit 13 is provided to a position away from the supply port 11, the deformation of the portion of the ejection port formation member 8 that is facing the supply port 11 is suppressed. In addition, in the present embodiment, all the support units 13 are provided at comparatively equal intervals more than the conventional technique along the first direction. Thus, the deformation of a portion other than the portion of the ejection port formation member 8 that is facing the supply port 11 is also suppressed.

Therefore, according to the printing element substrate 100 of the present embodiment, it is possible to suppress the breakage of the ejection port formation member 8.

In addition, according to the printing element substrate 100 of the present embodiment, the support unit 13 (see FIG. 4 and the like) is provided near the supply port 11; therefore, the interval 403 (see FIG. 4) between the two support units 13 adjacent to each other along the first direction with no supply port 11 being arranged therebetween is wide. In addition to this, in the second direction (the X direction), the length of the support unit 13 is formed smaller than the length of the supply port. Therefore, the flow of the liquid along the first direction (the Y direction) in the common liquid chamber 17 (see FIG. 4 and the like) is less likely to be inhibited.

Therefore, according to the printing element substrate 100 of the present embodiment, the decrease in the supply amount of the liquid to the liquid chamber 16 is suppressed, and it is possible to obtain the stable liquid ejection performance.

### Second Embodiment

An object of the present embodiment is to provide the printing element substrate 100 that can support the ejection port formation member 8 (see FIG. 2 and the like) without inhibiting the flow of the liquid. In the following description, a configuration that is similar to or corresponding to that of the first embodiment is provided with the same reference numerals and names while omitting the description thereof, and a different point is mainly described.

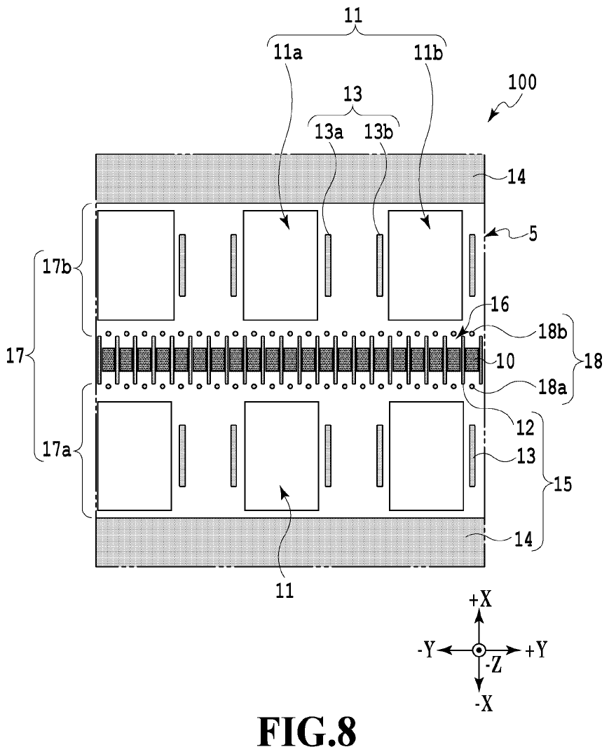

FIG. 8 is a schematic bottom view of the printing element substrate 100 that is applicable to the present embodiment. Note that, for the sake of explanatory convenience, in FIG. 8, the ejection port formation member 8 included in the printing element substrate 100 is not illustrated.

As illustrated in FIG. 8, in the printing element substrate 100 of the present embodiment, the length of the support unit 13 in the second direction (the X direction) and the length of the supply port 11 in the second direction (the X direction) are formed longer than that in the first embodiment.

Incidentally, for example, under the situation where the number of times of ejection of the liquid per hour is increased, or where the formation density of the ejection ports 9 (see FIG. 2 and the like) in each array of the ejection port array is increased to improve the image quality, it is necessary to increase the supply amount of the liquid in some cases. In order to increase the supply amount of the liquid, it is considered to increase the size of the supply port 11 in the first direction (the Y direction).

However, comparing with room for increasing the length of the supply port 11 in the second direction (the X direction), there is less room for increasing the length of the supply port 11 in the first direction. This is because, although it is not illustrated in FIG. 8, in reality, there is provided wiring for a power supply to the energy generation element 10 between the two supply ports 11 adjacent to each other along the first direction inside the substrate 5. In a case where the length of the supply port 11 in the first direction is tried to be increased despite the above, the supply port 11 penetrating the substrate 5 in the thickness direction (the Z direction) interferes the above-described wiring.

Therefore, in the present embodiment, the size of the supply port 11 is increased by making the length of the supply port 11 in the second direction longer than that in the first embodiment, and thus the supply amount of the liquid is further increased.

On the other hand, even in a case where the length of the supply port 11 in the second direction is made long, if the size of the support unit 13 is the same as that in the first embodiment, there is a possibility that the deformation amount of the portion of the ejection port formation member 8 that is facing the supply port 11 is increased more than that in the first embodiment.

Therefore, in the present embodiment, the length of the support unit 13 in the second direction is also increased according to the amount of the increased length of the supply port 11 in the second direction to suppress the deformation of the portion of the ejection port formation member 8 that is facing the supply port 11.

Specifically, in a state of viewing the printing element substrate 100 of the present embodiment from the bottom, the shape of the supply port 11 is rectangular, in which the length of the supply port 11 in the first direction is 85.0 μm, and the length in the second direction is 121.0 μm.

Additionally, in a state of viewing the printing element substrate 100 of the present embodiment from the bottom, the length of the support unit 13 in the first direction is 7.0 μm, and the length in the second direction is 72.0 μm.

That is, with the length of the support unit 13 in the second direction being set to be equal to or smaller than about 60% (72/121×100) of the length of the supply port 11 in the second direction, it is possible to support the ejection port formation member 8 without inhibiting the flow of the liquid.

More preferably, with the length of the support unit 13 in the second direction being set to be equal to or smaller than about 40% (48.4 μm) of the length of the supply port 11 in the second direction, it is possible to support the ejection port formation member 8 without inhibiting the flow of the liquid.

As described above, according to the printing element substrate 100 of the present embodiment, it is possible to support the ejection port formation member 8 without inhibiting the flow of the liquid while the opening area of the supply port 11 is made greater than that in the first embodiment.

### Third Embodiment

An object of the present embodiment is to provide the printing element substrate 100 that can support the ejection port formation member 8 (see FIG. 2 and the like) without inhibiting the flow of the liquid. In the following description, a configuration that is similar to or corresponding to that of the first and second embodiments is provided with the same reference numerals and names while omitting the description thereof, and a different point is mainly described.

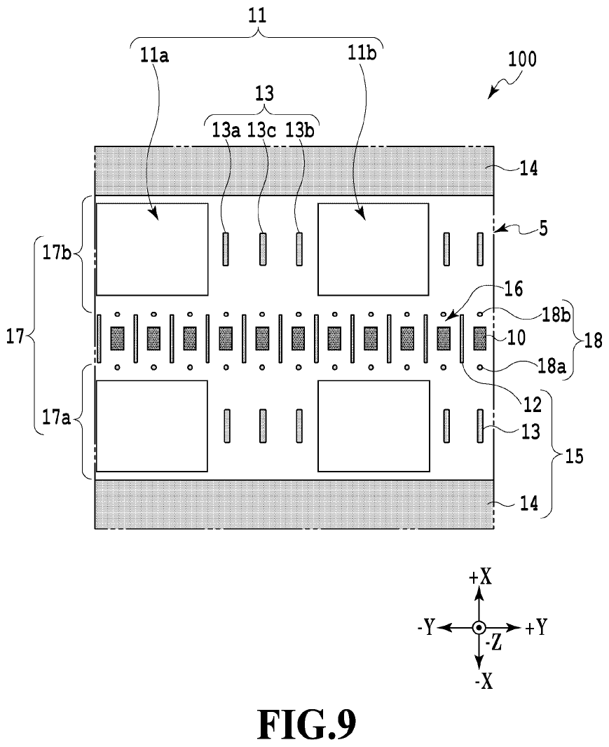

FIG. 9 is a schematic bottom view of the printing element substrate 100 that is applicable to the present embodiment. Note that, for the sake of explanatory convenience, in FIG. 9, the ejection port formation member 8 included in the printing element substrate 100 is not illustrated.

As illustrated in FIG. 9, in a state of viewing the printing element substrate 100 of the present embodiment from the bottom, the interval between the first supply port 11a and the second supply port 11b adjacent to each other along the first direction (the Y direction) is wider than that in the first embodiment. The support units 13 are provided between the first supply port 11a and the second supply port 11b at substantially equal intervals.

The support unit 13 in the present embodiment includes a third support unit 13c formed between the first support unit 13a and the second support unit 13b. In the first direction, the first support unit 13a is provided near the first supply port 11a, the second support unit 13b is provided near the second supply port 11b, and the third support unit 13c is provided between the first support unit 13a and the second support unit 13b.

Additionally, in the present embodiment, the density of the ejection ports 9 (see FIG. 2 and the like) and the energy generation elements 10 formed along the first direction is 600 dpi. That is, in the present embodiment, 600 ejection ports 9 and energy generation elements 10 per inch are formed along the first direction.

In addition, the density of the supply ports 11 formed along the first direction is 225 dpi. That is, in the present embodiment, 225 supply ports 11 per inch are formed along the first direction. In a case where 225 supply ports 11 per inch are formed along the first direction, an average value of the interval between the centers of the adjacent two supply ports 11 along the first direction is about 113.0 μm.

With this configuration, it is also possible to support the ejection port formation member 8 without inhibiting the flow of the liquid. That is, it is possible to suppress the shear stress and suppress the breakage of the ejection port formation member.

### Fourth Embodiment

An object of the present embodiment is to provide the printing element substrate 100 that can support the ejection port formation member 8 (see FIG. 2 and the like) without inhibiting the flow of the liquid. In the following description, a configuration that is similar to or corresponding to that of the first, second, and third embodiments is provided with the same reference numerals and names while omitting the description thereof, and a different point is mainly described.

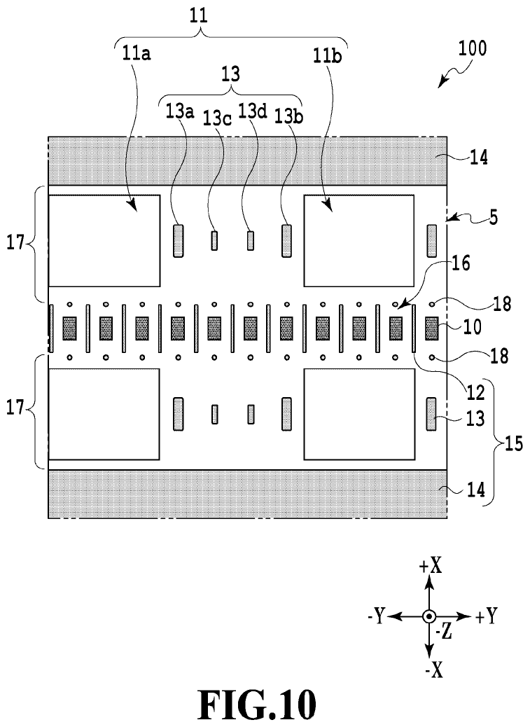

FIG. 10 is a schematic bottom view of the printing element substrate 100 that is applicable to the present embodiment. Note that, for the sake of explanatory convenience, in FIG. 10, the ejection port formation member 8 included in the printing element substrate 100 is not illustrated.

As illustrated in FIG. 10, in a state of viewing the printing element substrate 100 of the present embodiment from the bottom, the interval between the first supply port 11a and the second supply port 11b adjacent to each other in the first direction (the Y direction) is wider than that in the third embodiment. Four support units 13 are provided between the first supply port 11a and the second supply port 11b.

The support unit 13 of the present embodiment includes the third support unit 13c and a fourth support unit 13d formed between the first support unit 13a and the second support unit 13b. That is, the first support unit 13a, the third support unit 13c, the fourth support unit 13d, and the second support unit 13b are provided in this order along the first direction between the first supply port 11a and the second supply port 11b. Note that, in the present embodiment, the size of the third support unit 13c is smaller than that in the third embodiment.

The first support unit 13a provided to the position nearest the first supply port 11a and the second support unit 13b provided to the position nearest the second supply port 11b have the same size. The lengths of the first support unit 13a and the second support unit 13 b in the first direction are 11.5 μm.

The third support unit 13c and the fourth support unit 13d have the same size. The size of each of the third support unit 13c and the fourth support unit 13d is smaller than the size of each of the first support unit 13a and the second support unit 13b. According to the above-described configuration, comparing with a case where the four support units 13 are provided to the positions away from the two supply ports 11, the range of movement of the ejection port formation member 8 in the Z direction is reduced, and it is possible to make the deformation amount of the ejection port formation member 8 along with the ejection operation small. As a result, it is possible to suppress the shear stress on the ejection port formation member 8.

Additionally, in the present embodiment, the density of the ejection ports 9 (see FIG. 2 and the like) and the energy generation elements 10 formed along the first direction is 600 dpi. That is, in the present embodiment, 600 ejection ports 9 and energy generation elements 10 per inch are formed along the first direction.

In addition, the density of the supply ports 11 formed along the first direction is 150 dpi. That is, in the present embodiment, 150 supply ports 11 per inch are formed along the first direction. In a case where 150 supply ports 11 per inch are formed along the first direction, an average value of the interval between the centers of the two supply ports 11 adjacent to each other along the first direction is about 169.2 μm. According to the present embodiment as described above, it is assumed that a greater amount of the liquid than that in the above-described embodiment flows between the first supply port 11a and the second supply port 11b. However, since the third support unit 13c and the fourth support unit 13d positioned at substantially the center have a smaller size than that in the above-described embodiment, the flow of the liquid is not significantly inhibited.

That is, according to the configuration of the present embodiment, it is also possible to support the ejection port formation member 8 without inhibiting the flow of the liquid. That is, it is possible to suppress the shear stress and suppress the breakage of the ejection port formation member.

### Fifth Embodiment

An object of the present embodiment is to provide the printing element substrate 100 that can eject the liquid with small energy. In the following description, a configuration that is similar to or corresponding to that of the first, second, third, and fourth embodiments is provided with the same reference numerals and names while omitting the description thereof, and a different point is mainly described.

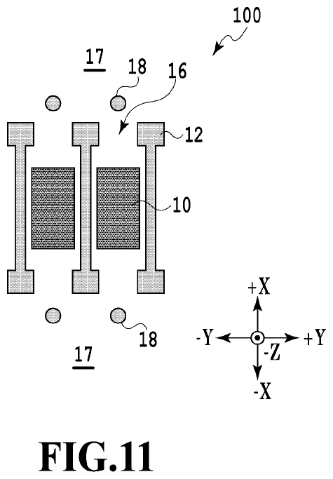

FIG. 11 is a schematic bottom view of the printing element substrate 100 that is applicable to the present embodiment. Note that, for the sake of explanatory convenience, in FIG. 10, the ejection port formation member 8 (see FIG. 2 and the like) included in the printing element substrate 100 is not illustrated. In addition, the vicinity of the liquid chamber 16 is enlarged to be illustrated.

As illustrated in FIG. 11, in the present embodiment, two end portions of the partition 12 in the second direction (the X direction) have the length in the first direction (the Y direction) longer than the length of another portion in the first direction (the Y direction). According to this configuration, the width (the length in the Y direction) of the inlet and outlet port in the liquid chamber 16 is made narrower than that in the first embodiment. As described above, with the width of the inlet and outlet port in the liquid chamber 16 being made narrower than the central portion of the liquid chamber 16, it is possible to eject the liquid with less energy.

Therefore, according to the printing element substrate 100 of the present embodiment, comparing with a case where shape of the liquid chamber 16 is a straight shape, it is possible to eject the liquid with less energy. The above-described configuration of the present embodiment can be adopted to all the embodiments described above.

### Other Embodiments

In the above-described embodiments, the heater is used as the energy generation element 10. However, the element that can be used as the energy generation element 10 is not limited to the heater. For example, a piezoelectric element (a piezo element) may be used as the energy generation element 10. Thus, a so-called piezo method to change a volume by applying a voltage to the piezoelectric element and eject the liquid by using the energy generated in the process may be adopted as the printing method. As a matter of course, a printing method other than the above may be adopted.

In the first embodiment, in a case where about 1200 ejection ports 9 per inch are formed along the first direction, about 150 supply ports 11 per inch are formed along the first direction. However, an example of the density of the ejection ports 9 and the supply ports 11 formed is not limited thereto. The array density of the ejection ports 9 and the energy generation elements 10 can be changed as needed according to application and the like of the liquid ejection head, and the opening area and the array density of the supply ports 11 may be adjusted as needed according to a flow rate along with the ejection operation. Besides, in a case where the support unit 13 is provided at least at a position close to each supply port between the adjacent two supply ports 11 of the multiple supply ports 11 provided as described above, it is possible to exert the effect of the present disclosure.

For example, along the first direction, about 300 supply ports 11 per inch may be formed, or about 75 supply ports 11 per inch may be formed. In a case where about 75 supply ports 11 per inch are formed, the interval between the two supply ports may be about 84.7 μm. Alternatively, the multiple supply ports 11 may be formed at the density of equal to or smaller than 37.5% of the density of the multiple ejection ports 9 formed along the first direction, may be formed at the density of equal to or smaller than 25.0%, or may be formed at the density of equal to or smaller than 12.5%. According to the configuration as described above, it is also possible to obtain the effect of the present disclosure.

The above-described embodiments are described assuming a case where the liquid ejection apparatus 2 is an ink jet printer. However, the technique of the present disclosure can be applied to also an apparatus other than the ink jet printer as long as it is formed to be able to eject the liquid.

The above embodiments are described assuming a case where all the multiple supply ports are openings to supply the liquid chamber with the liquid. However, it is unnecessary to use all the multiple supply ports as the openings for supply. In a case where circulation of the liquid is performed between a tank provided outside and the liquid chamber, a part of the multiple supply ports is used as a collection port to collect the liquid. As with the portion facing the supply port, there is a problem of the shear stress also in a portion facing the collection port. Accordingly, also in a case of the configuration in which the liquid ejection head can perform the circulation of the liquid, the application of the technique of the present disclosure makes it possible to suppress the deformation amount of the ejection port formation member along with the ejection operation and suppress the shear stress on the ejection port formation member 8.

In the above embodiments, a so-called serial type liquid ejection head 1 that performs printing while performing scanning on the printing medium P is used. However, the technique of the present disclosure is also applicable to a so-called line type head that has a length corresponding to the width of the printing medium P (the length in the X direction).

In the above embodiments, the ejection port array for the black ink and the ejection port array for the color ink are formed for a single printing element substrate 100. However, an example of the configuration to eject the liquid is not limited thereto. For example, a printing element substrate for the black ink and a printing element substrate for the color ink may be each attached to a single liquid ejection head 1 individually. Alternatively, a short line head that is smaller than the width of the printing medium P, in which the multiple printing element substrates 100 are arranged such that multiple ejection port arrays overlap along the direction in which the ejection port arrays extend, may be created, and the line head may be scanned on the printing medium P.

In the above embodiments, the ink is used as the liquid; however, the liquid that can be used for the technique of the present disclosure is not limited to the ink. Other than the ink, various printing liquids including a treatment liquid and the like used for the purpose of improving fixability of the ink, reducing glossy unevenness, and improving abrasion resistance on the printing medium can also be used as the liquid.

In the above embodiments, the ejection port formation member 8 and the flow channel formation member 15 are members different from each other. However, a plate member that includes the ejection port 9 included in the ejection port formation member 8 and the first common liquid chamber 17a, the liquid chamber 16, and the second common liquid chamber 17b included in the flow channel formation member 15 may be used. That is, in a case where the plate member is used, the plate member includes a flow channel formation unit in which the first common liquid chamber 17a, the liquid chamber 16, and the second common liquid chamber 17b are formed and an ejection port formation unit in which the multiple ejection ports 9 are formed. In addition, the printing element substrate 100 is formed by connecting the substrate 5, the flow channel formation unit, and the ejection port formation unit in this order.

With this configuration, the support unit 13 is formed in the flow channel formation unit. For example, in the flow channel formation unit, the first support unit 13a and the second support unit 13b are formed. In addition, in the flow channel formation unit, the third support unit 13c and the fourth support unit 13d that support the ejection port formation unit may be formed between the first support unit 13a and the second support unit 13b. Thus, also in a case of using a single member that includes constituents included in each of the ejection port formation member 8 and the flow channel formation member 15, it is possible to obtain the effect of the present disclosure.

According to a printing element substrate of the present disclosure, it is possible to suppress breakage of an ejection port formation unit.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-009782, filed Jan. 23, 2025, which is hereby incorporated by reference herein in its entirety.

What is claimed is:

1. A printing element substrate, comprising:
a substrate in which a plurality of energy generation elements configured to generate energy to eject a liquid are formed;
a flow channel formation unit in which a flow channel is formed; and
an ejection port formation unit in which a plurality of ejection ports to eject the liquid are formed, wherein the substrate, the flow channel formation unit, and the ejection port formation unit are connected to each other in this order,
in the substrate, a plurality of supply ports including a first supply port and a second supply port adjacent to each other in a first direction and configured to supply the ejection ports with the liquid are formed,
in the flow channel formation unit, a first support unit and a second support unit configured to support the ejection port formation unit are formed between the first supply port and the second supply port, and
in the first direction, a distance from the first support unit to a midpoint between the first support unit and the second support unit is longer than a distance from the first support unit to the first supply port, and
a distance from the second support unit to the midpoint between the first support unit and the second support unit is longer than a distance from the second support unit to the second supply port.

2. The printing element substrate according to claim 1, wherein
the flow channel formation unit is formed in a flow channel formation member different from a member in which the ejection port formation unit is formed,
the ejection port formation unit is formed in an ejection port formation member different from the flow channel formation member, and
the substrate, the flow channel formation member, and the ejection port formation member are laminated in this order.

3. The printing element substrate according to claim 1, wherein
a length of the first support unit extending along a second direction crossing the first direction on a plane is equal to or smaller than 60% of a length of the first supply port extending along the second direction, and
a length of the second support unit extending along the second direction is equal to or smaller than 60% of a length of the second supply port extending along the second direction.

4. The printing element substrate according to claim 3, wherein
the length of the first support unit extending along the second direction is equal to or smaller than 40% of the length of the first supply port extending along the second direction,
the length of the second support unit extending along the second direction is equal to or smaller than 40% of the length of the second supply port extending along the second direction.

5. The printing element substrate according to claim 1, wherein
the plurality of ejection ports are formed along the first direction, and
the plurality of supply ports are formed along the first direction at a density equal to or smaller than 37.5% of a density of the plurality of ejection ports formed.

6. The printing element substrate according to claim 1, wherein
the plurality of supply ports are formed along the first direction at a density equal to or smaller than 25.0% of a density of the plurality of ejection ports formed.

7. The printing element substrate according to claim 1, wherein
the plurality of supply ports are formed along the first direction at a density equal to or smaller than 12.5% of a density of the plurality of ejection ports formed.

8. The printing element substrate according to claim 1, wherein
the plurality of supply ports are formed along the first direction at a density of 150 pieces per inch.

9. The printing element substrate according to claim 1, wherein
the plurality of supply ports are formed along the first direction at a density of 225 pieces per inch.

10. The printing element substrate according to claim 1, wherein
the plurality of supply ports are formed along the first direction at a density of 300 pieces per inch.

11. The printing element substrate according to claim 1, wherein
in the flow channel formation unit, a third support unit configured to support the ejection port formation unit is additionally formed between the first support unit and the second support unit.

12. The printing element substrate according to claim 1, wherein
in the flow channel formation unit, a third support unit and a fourth support unit configured to support the ejection port formation unit are additionally formed between the first support unit and the second support unit.

13. The printing element substrate according to claim 12, wherein
the third support unit and the fourth support unit have smaller lengths in the first direction and a second direction crossing the first direction on a plane is smaller than that of the first support unit and the second support unit.

14. The printing element substrate according to claim 1, wherein
in the substrate, the plurality of energy generation elements are formed at positions corresponding to the plurality of ejection ports, respectively, along the first direction,
in the flow channel formation unit, a plurality of liquid chambers corresponding to the plurality of energy generation elements, respectively, are provided,
each of the plurality of liquid chambers is formed of a plurality of partitions arranged in the first direction in the flow channel formation unit, and
each of the plurality of partitions extends along a second direction crossing the first direction on a plane.

15. The printing element substrate according to claim 14, wherein
in the flow channel formation unit, a filter configured to suppress entering of a foreign substance into the liquid chamber is additionally formed near an inlet and outlet port of the liquid chamber.

16. The printing element substrate according to claim 14, wherein
in each of the plurality of partitions, a length in the first direction of two end portions in the second direction is longer than a length in the first direction of a central portion in the second direction.

17. A liquid ejection head, comprising:
a printing element substrate including a substrate in which a plurality of energy generation elements configured to generate energy to eject a liquid are formed, a flow channel formation unit in which a flow channel is formed, and an ejection port formation unit in which a plurality of ejection ports to eject the liquid are formed, wherein
the substrate, the flow channel formation unit, and the ejection port formation unit are connected to each other in this order,
in the substrate, a plurality of supply ports including a first supply port and a second supply port adjacent to each other in a first direction and configured to supply the ejection ports with the liquid are formed,
in the flow channel formation unit, a first support unit and a second support unit configured to support the ejection port formation unit are formed between the first supply port and the second supply port, and
in the first direction, a distance from the first support unit to a midpoint between the first support unit and the second support unit is longer than a distance from the first support unit to the first supply port, and
a distance from the second support unit to the midpoint between the first support unit and the second support unit is longer than a distance from the second support unit to the second supply port.
